(19) United States
(12) Patent Application Publication
(10) Pub. No.: US 2007/0209263 A1
(43) Pub. Date: Sep. 13, 2007

(54) METHOD OF RELATING DIFFERENT PRODUCTS BY A COMMON FEATURE

(76) Inventors: Douglas J. Hohlbein, Pennington, NJ (US); Steven M. Sorrel, New York, NY (US); Michael C. Rooney, Shanghai (CN)

Correspondence Address: COLGATE-PALMOLIVE COMPANY, 909 RIVER ROAD, PISCATAWAY, NJ, 08855, US

(21) Appl. No.: 11/681,810

(22) Filed: Mar. 5, 2007

Related U.S. Application Data
(60) Provisional application No. 60/781,222, filed on Mar. 10, 2006.

(51) Int. Cl. G09F 3/02

(52) U.S. Cl. 40/625

(57) ABSTRACT

A kit and method of relating products by a common feature include the provision of a first product having a first feature providing a first consumer-relevant benefit, and a second different product having a second feature providing a second consumer-relevant benefit, wherein the first and second features have a consistent appearance and wherein at least one feature has a different consumer-relevant benefit relative to the other feature.

### CROSS-REFERENCE TO RELATED APPLICATION

This application claims the benefit of priority to U.S. Application No. 60/781,222, filed Mar. 10, 2006, the contents of which is incorporated herein by reference.

### FIELD OF THE INVENTION

The present invention relates to a method of associating different products by common consumer-relevant features.

### BACKGROUND OF THE INVENTION

It is known in the art to associate two different products by aesthetic features alone. For example, a screwdriver and a hammer from the same manufacturer may have the same color, handle shape, texture or the like. The manufacturer relates such products together to influence collective purchasing. Another example is represented by a set of kitchen utensils from the same manufacturer that has an identically-configured handle. Yet another example is where compositional products such as hand soaps and body soaps are provided with aesthetically-appealing suspended articles such as colored beads or the like.

In each of the above examples, the products are related solely by aesthetic features. However, the related features do not transcend the aesthetic into the functional or multi-functional as provided herein.

### SUMMARY OF THE INVENTION

A kit and method of relating products by a common feature include the provision of a first product comprising a first feature providing a first consumer-relevant benefit, and a second different product comprising a second feature providing a second consumer-relevant benefit, wherein the first and second features comprise a consistent appearance and wherein at least one feature comprises a different consumer-relevant benefit relative to the other feature. A further method includes assisting consumers in purchasing related products by providing visual cues that link such products. A further method includes packaging different products that are united by a consistent feature, such as a strip, with such feature differing in consumer-relevant benefit between the products.

### BRIEF DESCRIPTION OF THE DRAWINGS

FIG. 1 illustrates a dentifrice for demonstrating an aspect of the present invention.

FIGS. 2-3 illustrate a front view and side view of a toothbrush for demonstrating an aspect of the present invention.

FIG. 4 illustrates a package of the dentifrice of FIG. 1 and the toothbrush of FIGS. 2-3.

FIG. 5 illustrates a point-of-purchase display for demonstrating an aspect of the present invention.

FIG. 6 illustrates another point-of-purchase display for demonstrating an aspect of the present invention.

FIG. 7 illustrates a bar of soap for demonstrating an aspect of the present invention.

FIG. 8 illustrates a bottle of shampoo for demonstrating an aspect of the present invention.

FIG. 9 illustrates a package of the soap of FIG. 7 and the shampoo of FIG. 8.

FIG. 10 illustrates a package of the dentifrice of FIG. 1, the toothbrush of FIGS. 2-3, the soap of FIG. 7 and the shampoo of FIG. 8.

FIGS. 11A-11F illustrate various embodiments of strip-like features for demonstrating an aspect of the present invention.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

FIGS. 1-3 illustrate two different products, namely a dentifrice 100 and a toothbrush 200, that are related by a common feature and that are illustrated herein to demonstrate certain aspects of one embodiment of the present invention. Specifically, FIG. 1 illustrates a representation of dentifrice 100 currently sold in a container 110, a portion of which is see-through. The container is generally illustrated in U.S. Pat. No. D512,317, incorporated by reference herein. The dentifrice 100 comprises a carrier 120 having suspended square-shaped features or strips 130 of material that provide a consumer-relevant benefit or function and are advertised as breath-freshening strips that dissolve instantly to give the consumer a burst of fresh breath. While such strips 130 are illustrated as square-shape, a variety of shapes and configurations may be used as desired, such as, but not limited to a rounded shape (FIG. 11A) in the form of beads, polygonal (FIG. 11B—triangle shape, FIG. 11D—hexagon shape, FIG. 11E—star shape), multi-curved (FIG. 11C—heart shape), alpha-numeric shapes such as a company logo (FIG. 1F), or recognizable figures such as licensed fictional characters, cartoon or pop culture icons (not shown), or combinations of the same. One example of a dentifrice incorporating strips based on functional film flakes is U.S. Pat. No. 6,669,929, incorporated by reference herein. Strips 130 contribute a unique consumer-relevant aesthetic benefit to the dentifrice 100 that is eye-catching both at the point of purchase and during dispensing from the container 110 (not shown). Strips 130 could also contribute a therapeutic or cosmetic benefit to the user, such as breath freshening as currently advertised. Other potential consumer-relevant benefits include the delivery of flavors, actives, whitening agents (peroxides, carbonates), antibacterial agents, anti-plaque agents, argine esters, keratin, abrasives, menthol, thymol, delmopinal, zinc ions, moisturizers, essential oils, enzymes, bleaching agents, silver ions, triclosan, other cosmetic or aesthetic enhancements, and additional benefits as described in the '929 patent. Thus, strips 130 are multi-functional, providing an aesthetic function and at least one additional function or benefit to the consumer that is non-aesthetic.

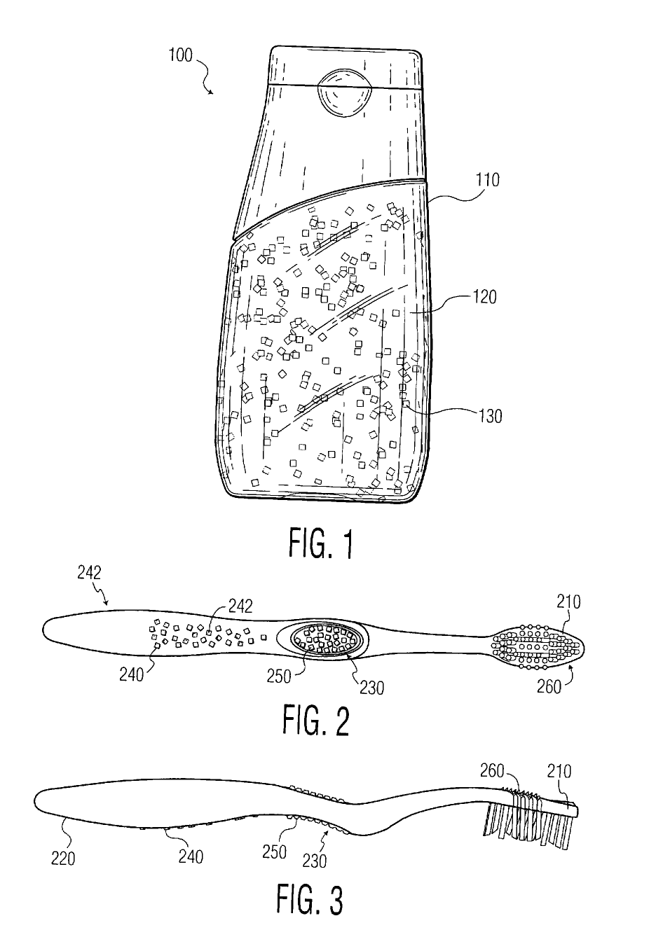

FIGS. 2 and 3 illustrate a toothbrush 200 having a head 210, a handle 220, a thumb grip 230 and square-shaped, strip-like features or elements that are raised or extend outwardly (240, 250) from, or are recessed (242) relative to, the handle 220 and thumb grip 230 respectively, which elements 240, 242, 250 are preferably molded as part of the handle 220 and thumb grip 230 respectively. Such elements 240, 242, 250 have an appearance that is consistent with the appearance of the strips 130 of dentifrice 100 (see FIG. 1), and contribute a unique consumer-relevant aesthetic benefit to the toothbrush 200 that is eye-catching at the point of purchase. Elements 240, 242, 250 also contribute an additional, ergonomic benefit in form of enhanced handling and gripability by providing additional tactile outer surfaces on the toothbrush 200.

One embodiment provides visual cues in a first product, i.e., dentifrice 100, to help correlate the first product 100 with a second product, i.e. toothbrush 200 in the minds or eye of a consumer. Advantageously, one embodiment of an oral care product provides a benefit for a consumer to use a particular dentifrice in combination with a particular toothbrush. To help reinforce the appropriate products to be used together, aspects of the various embodiments include design features in the first product to help reinforce the selection of the recommended second product. To further illustrate this concept using FIGS. 1-3, it may be desirable for a consumer particularly interested in fresh breath benefits to use toothbrush 200 with a tongue and cheek cleaning feature 260 on the rear of the head 210 in combination with a dentifrice 100 with breath freshening strips 130. To help reinforce this combination of products, the strip-like features 130 of the dentifrice 100 have a visual appearance or aesthetic that is consistent with that of the strip-like features 240, 242, 250. The strip-like features 240, 242, 250 could be represented in any number of ways, such as outwardly or inwardly molded features in the handle, and/or embedded in a clear or translucent handle material, offering similar visibility to the strip-like features 130 in the dentifrice 100. Colors and applied graphics, for example, can be used to further strengthen the link between the distinct features being aligned.

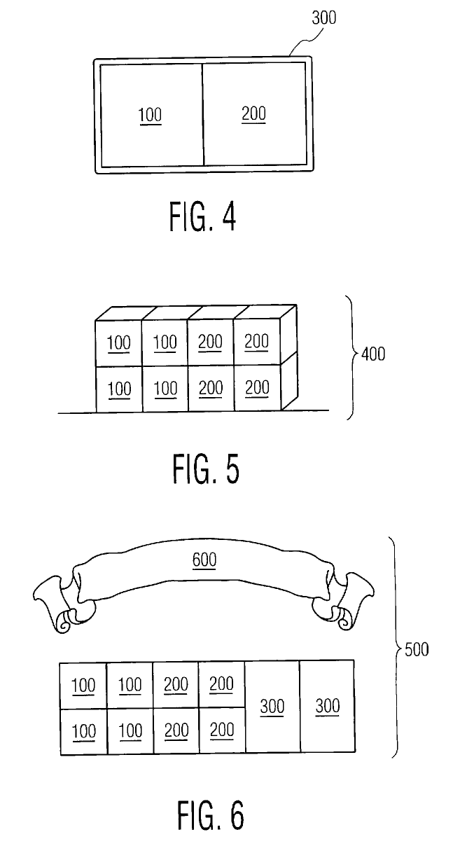

To further reinforce the relationship, products 100 and 200 may be vended together as a package 300 as shown in FIG. 4, or in close proximity to each other as shown in a representative point-of-purchase shelf display 400 in FIG. 5. Building upon the relationship, an advertising campaign 500 (FIG. 6) could be created, wherein the products 100, 200 are individually vended in close proximity with packaged bundles 300 (FIG. 4) of products 100, 200, and are related by an additional theme element such as a banner 600 that is additionally representative of the relationship between the products. For example, such banner 600 might communicate or proclaim the message “Strips Alive!!”, for example, to further highlight the strip-like elements 130, 240, 242, 250 in the respective products 100, 200. Further support or means for communicating information about, or instructions for using the package 300, for example, may include a document provided at the point of purchase, digital storage media, audio presentations, or visual displays containing the information or instructions related to the package 300, display 400 or campaign 500. This may be reinforced by brochures, product labels and package insert on or in connection with the products, advertisements, a displayed web site, and a visual display in connection with the products.

FIGS. 4-6 also illustrate methods of associating one or more products with a consistent feature, where such feature delivers or could deliver a different consumer-relevant benefit in each product. As discussed above, while the strip-like elements 130, 240, 242, 250 deliver certain aesthetic benefits that are consistent across products 100, 200, the strip-like elements 130 deliver additional breath-freshening benefits, while the strip-like elements 240, 250 deliver enhanced gripping benefits. In this manner, the consumer associates the consistent feature as a source-indicator, even if the feature performs additional dissimilar consumer-relevant functions across different product lines. Thus, if a dentifrice 100 and toothbrush 200 are vended with similarly appearing strip-like features, the consumer will recognize or come to recognize a future strip-like product, such as mouthwash with tingle-enhancing strips for example, as originating with the same source, even if the strip in such other product delivers yet an additional consumer-relevant benefit.

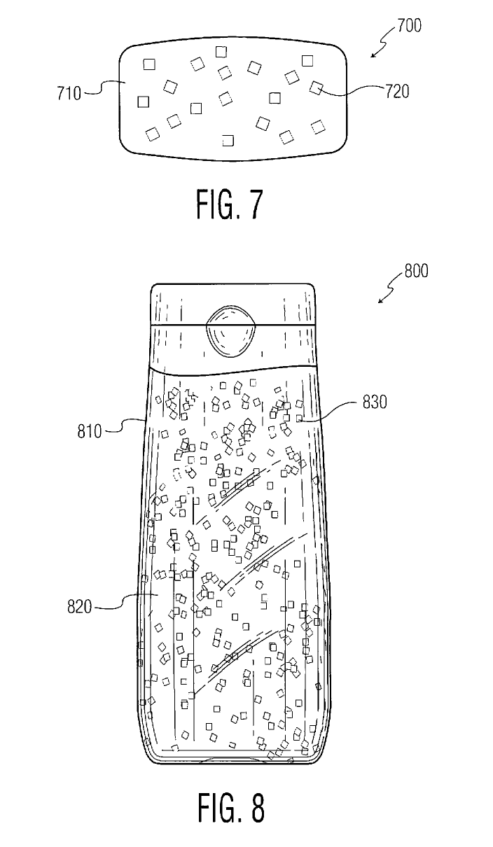

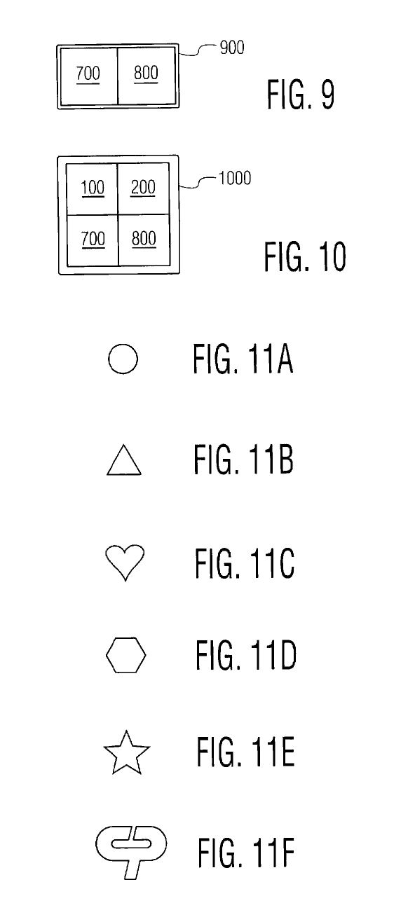

FIGS. 7 and 8 illustrate yet additional products outside of the oral care field that are united or related by a consistent feature. FIG. 7 illustrates a bar of soap 700 formed from a carrier 710 with suspended square-shaped, strip-like elements 720 that could deliver a variety of consumer-relevant benefits in addition to aesthetic appeal. For example, the strip-like elements 720 could be vitamin-enriched or provide additional skin-moisturizing benefits. FIG. 8 illustrates shampoo 800 (and/or conditioner if desired) in a container 810 that includes a carrier 820 with suspended square-shaped, strip-like feature elements 830 that could deliver a variety of consumer-relevant benefits in addition to aesthetic appeal. For example, the strip-like feature elements 830 could provide a cooling sensation, dandruff relief, or the like. FIG. 9 illustrates the vending of soap 700 and shampoo 800 as a personal care package 900.

FIG. 10 illustrates the vending of a “beauty package” 1000 including dentifrice 100 (FIG. 1), toothbrush 200 (FIGS. 2-3), soap 700 (FIG. 7) and shampoo 800 (FIG. 8), each related by a feature that is consistent in appearance and differs in consumer-relevant function or benefit across products. Of course, products that are not related to oral care, personal care or the like are contemplated herein. For example, and continuing with the above examples, a hard surface cleaner formulated for glass and mirrors might have shine-enhancing strips, while another hard surface cleaner formulated for tile might have grout-whitening strips, with the strips being consistent in appearance, yet differing in function, but preferably noticeable to the consumer at the point of purchase.

While the present invention has been described and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the inventions, not presently foreseen, may nonetheless represent equivalents thereto.

What is claimed is:

1. A kit comprising:
a) a first product comprising a first feature providing a first consumer-relevant benefit; and
b) a second different product comprising a second feature providing a second consumer-relevant benefit;
c) wherein the first and second features comprise a common thematic appearance; and
d) wherein at least one feature comprises a different consumer-relevant benefit relative to the other feature.

2. The kit of claim 1, wherein the features have the same shape.

3. The kit of claim 2, wherein the shape is rounded.

4. The kit of claim 3, wherein the features are beads.

5. The kit of claim 2, wherein the shape is polygonal.

6. The kit of claim 5, wherein the features are strips.

7. The kit of claim 1, wherein the features have the shape of a logo.

8. The kit of claim 1, wherein the first and second features each comprise the same combination of different shapes.

9. The kit of claim 1, wherein the feature that does not comprise an additional consumer-relevant benefit consists of a purely aesthetic benefit.

10. The kit of claim 1, wherein the first product is a toothbrush and the second product is a dentifrice.

11. The kit of claim 10, wherein the features are strip-like features.

12. The kit of claim 11, wherein the first feature enhances handling of the toothbrush.

13. The kit of claim 12, wherein the first feature further comprises at least one raised or recessed strip-like feature on an outer surface of the toothbrush.

14. The kit of claim 13, wherein the first feature is positioned on a handle of the toothbrush.

15. The kit of claim 13, wherein the first feature is positioned on a thumb grip portion of the toothbrush.

16. The kit of claim 12, wherein the second feature is a strip-like feature that provides a therapeutic and/or cosmetic benefit.

17. The kit of claim 16, wherein the second feature is a strip-like film.

18. The kit of claim 17, wherein the second feature is suspended in a carrier.

19. The kit of claim 17, wherein the therapeutic or cosmetic benefit results in breath freshening or provides for flavor delivery, active delivery or aesthetic enhancement.

20. The kit of claim 1, wherein one feature is suspended in a carrier and the other feature is not.

21. The kit of claim 20, wherein the other feature is formed on an outer surface of its respective product.

22. The kit of claim 1, wherein the first product is an oral care product and the second product is not an oral care product.

23. The kit of claim 22, wherein the first product is a toothbrush or dentifrice.

24. The kit of claim 23, wherein the second product is a skin care product, hair care product or hard surface cleaner.

25. The kit of claim 24, wherein the second product is a soap, shampoo or hair conditioner.

26. The kit of claim 1, including a means of communicating the association of a product via a document, digital storage media, audio presentation, or visual display containing the information or instructions.

27. The kit of claim 26, wherein the means is selected from the group consisting of brochure, product label, package insert, advertisement, displayed web site, and visual display.

28. A kit comprising:
a) a toothbrush comprising a raised or recessed feature that enhances handling of the toothbrush by a consumer; and
b) a dentifrice comprising a suspended feature that provides a therapeutic or cosmetic benefit to a consumer;
c) wherein the raised or recessed feature and the suspended features comprise a consistent appearance.

29. The kit of claim 28, wherein the features have a strip-like appearance.

30. The kit of claim 28, wherein the features have the same shape.

31. The kit of claim 30, wherein the shape is polygonal.

32. The kit of claim 30, wherein the shape is rounded.

33. The kit of claim 30, wherein the shape is a logo.

34. The kit of claim 30, wherein the suspended feature comprises a breath freshener.

35. A method of associating different products comprising the steps of:
a) providing a first product comprising a first feature providing a first consumer-relevant benefit;
b) providing a second different product comprising a second feature providing a second consumer-relevant benefit; and
c) relating the first and second products by the first and second features;
d) wherein the first and second features comprise a consistent appearance; and
e) wherein at least one feature comprises a different consumer-relevant benefit relative to the other feature.

36. The method of claim 35, further comprising the step of providing a theme element that relates to the features of the first and second products.

37. The method of claim 36, wherein the theme element is communicative of the first and second features.
